(19) United States
(12) Patent Application Publication
(10) Pub. No.: US 2001/0016784 A1
(43) Pub. Date: Aug. 23, 2001

(54) Audio data storage device

(75) Inventor: Katsushige Matsubara, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/788,490

(22) Filed: Feb. 21, 2001

(30) Foreign Application Priority Data
Feb. 22, 2000 (JP) P2000-044966

(51) Int. Cl. G06F 17/00; G10L 11/00; G10L 21/00

(52) U.S. Cl. 700/94; 381/61; 704/270; 704/500

(57) ABSTRACT

The audio data storage device of the present invention comprises: a storage device for storing audio data; a channel detector for detecting a channel of the audio data; an input sample number detector for detecting the number of samples of the audio data to be written into the storage device; an output sample number detector for detecting the number of samples of the audio data to be read from the storage device; an address generator for generating an address for writing and reading the audio data based on the channel detected by the channel detector, the number detected by the input sample number detector, the number detected by the output sample number detector, the number of channels of the audio data, and the number of samples included in one channel; and a controller for directing the storage device to read and write the audio data based on the address generated by the address generator.

### BACKGROUND OF THE INVENTION

1. Field of the Invention

The present invention relates to an audio data storage device for temporarily storing audio data and processing the audio data.

2. Description of the Related Art

MPEG2-AAC can transfer six channels of coded audio data, for example. The audio data in each channel is divided into frames. A frame means a unit of transferred data which contains 1024 PCM (Pulse Code Modulation) data units.

An audio data storage device decodes the audio data on a frame basis, and temporarily stores and outputs the decoded PCM data. FIG. 8 is a schematic block diagram showing the structure of a conventional audio data storage device. In FIG. 8, a multiplier 101 outputs the product of the number of channels Mch of the audio data to be decoded and a sampling index nsample which is time data corresponding to the sampling time of a plurality of PCM data in one frame.

An adder 102 outputs the sum of the output from the multiplier 101 and a channel index nch which represents the channel number to be decoded. A selector 103 sets an output address depending on an externally set parameter γ. For example, when the parameter γ is set to 0, the output from the adder 102 is supplied as an address D to a buffer memory 104. When the parameter γ is set to 1, the output from the adder 102 is supplied as an address G to a buffer memory 105.

When storing the PCM data, the buffer memory 104 stores input data E, which is the PCM data to be temporarily stored, to an address D specified by the selector 103. When outputting the PCM data, the buffer memory 104 outputs the PCM data, which has been stored at the address D specified by the selector 103, as output data F. When storing the PCM data, the buffer memory stores input data H, which is the PCM data to be temporarily stored, to the address G specified by the selector 103. The buffer memory 105 outputs the PCM data, which has been stored at the address G specified by the selector 103, as output data I.

However, because there is only a single list of the PCM data stored in the buffer memory, the single buffer memory overwrites the next frame data on the present frame data which has not yet been output. Therefore, as shown in FIG. 9, the conventional audio data storage device stores the decoded PCM data, which is output from a decoder 110, into the buffer memory 104 while outputting the PCM data stored in the buffer memory 105 to a D/A converter 111 for converting the digital data into analog data (FIG. 9A). Further, while outputting the PCM data from the buffer memory 104 to the D/A converter 111, the buffer memory 105 stores the decoded PCM data output from the decoder 110 (FIG. 9B).

Therefore, the conventional audio data storage device requires two buffer memories. For example, 5.1 ch (6 ch) of MPEG2-AAC requires two buffer memories, each of which can store 6144 samples (12288 samples in total). Thus, there is the problem in that the capacity of the buffer memories must be large.

To solve this problem, a method using a single memory has been proposed (in Japanese Unexamined Patent Application, First Publication No. Hei 10-271082). This method divides the buffer memory for storing the PCM data into a plurality of regions. Further, a register for storing values which indicates whether the PCM data can be written into the divided regions, and a storage section for storing time information for outputting the PCM data from the regions, are provided. A controller outputs the PCM data from the buffer memory based on the time information stored in the storage section. Whenever the PCM data is output from the buffer memory, the controller records in the register that the region from which the PCM data has been output is writable. When the PCM data is input from an external device, the data is stored into the storage region in the buffer memory based on the information stored in the register. This method requires the subdivision and management of the buffer memory to reduce the size of the buffer memory.

The method of Japanese Unexamined Patent Application, First Publication No. Hei 10-271082 has the problem in that the subdivision of the storage region disadvantageously increases the size of the register and the storage section. Further, when the buffer memory is subdivided, the number of storage regions to be managed is increased, and the control becomes complicated, thereby increasing the size of the hardware and software.

### BRIEF SUMMARY OF THE INVENTION

Therefore, an object of the present invention is to provide an audio data storage device which can reduce the size of the buffer memory.

Another object of the present invention is to provide an audio data storage unit which can reduce the size of the hardware and software.

In the first aspect of the present invention, the audio data storage device comprises: a storage device 18 for storing audio data; a channel detector (input PCM data buffer) 16 for detecting a channel of the audio data; an input sample number detector (input PCM counter) 15 for detecting the number of samples of the audio data to be written into the storage device; an output sample number detector (output PCM counter) 14 for detecting the number of samples of the audio data to be read from the storage device; an address generator 17 for generating an address for writing and reading the audio data based on the channel detected by the channel detector, the number detected by the input sample number detector, the number detected by the output sample number detector, the number of channels Mch of the audio data, and the number of samples Msample included in one channel; and a controller 13 for directing the storage device to read and write the audio data based on the address generated by the address generator.

In the second aspect of the present invention, the audio data storage device further comprises a decoder (decoding processor) 12 for decoding coded audio data. The storage device stores the decoded audio data.

In the third aspect of the present invention, the controller detects the number of channels and the number of samples included in the coded audio data, and outputs those numbers to the address generator.

In the fourth aspect of the present invention, the audio data storage device further comprises an encoder (encoding processor) 22 for encoding audio data with a plurality of channels. The storage device stores the audio data which is to be encoded.

In the fourth aspect of the present invention, the controller 13 stores the number of channels and the number of samples included in the encoded audio data, in advance.

In the fifth aspect of the present invention, the address generator generates an address of the data which is to be read, in response to an instruction from the controller to read the data, and the address generator generates an address of the data which has been read, in response to an instruction from the controller to write the data.

In the sixth aspect of the present invention, the address generator comprises: a first address generator (mode 0) for specifying a first sequence of addresses; and a second address generator (mode 1) for specifying a second sequence of addresses. The controller directs the storage device to read and write the audio data while alternately switching the first address generator and the second address generator (by a control signal, or parameter β).

In the seventh aspect of the present invention, the storage device, the channel detector, the input sample number detector, the output sample number detector, the address generator, and the controller are provided in a semiconductor device.

In the eighth aspect of the present invention, the computer-readable storage medium contains program instructions for performing the steps comprising: a storage step for storing the audio data; a channel detecting step for detecting a channel of the audio data; an input sample number detecting step for detecting the number of samples of the audio data to be written in the storage step; an output sample number detecting step for detecting the number of samples of the audio data to be read in the storage step; an address generating step for generating an address for writing and reading the audio data, based on the channel detected by the channel detecting step, the number detected by input sample number detecting step, the number detected by the output sample number detecting step, the number of channels of the audio data, and the number of samples included in one channel; and a control step for directing the storage step to read and write the audio data based on the address generated by the address generating step.

In the ninth aspect of the present invention, the program instructions for performing the steps further comprises a decoding step for decoding coded audio data. The storage step stores the decoded audio data.

In the tenth aspect of the present invention, the program instructions for performing the steps further comprises an encoding step for encoding audio data with a plurality of channels. The storage step stores the audio data which is to be encoded.

According to the present invention, the channel detector detects the number of channels of the audio data. The input sample number detector detects the number of samples of the audio data to be written into the storage device. The address generator generates an address for writing the audio data based on the results of the detections, the number of channels of the audio data, and the number of samples included in one channel. Further, the output sample number detector detects the number of samples of the audio data to be read from the storage device. The address generator generates an address for reading the audio data based on the results of the detections, the number of channels of the audio data, and the number of samples included in one channel. Therefore, the size of the storage region can be decreased, and the size of the data buffer can be decreased.

Further, the storage device stores the audio data according to the first sequence of addresses specified by the first address generator. Then, the audio data is read according to the first sequence of addresses. Other audio data is then written into the addresses from which the audio data is read according to the second sequence of addresses specified by the second address generator. The audio data is then read according to the second sequence of addresses. Other audio data is then written according to the first sequence of addresses. Thus, the audio data is read and written while the first address generator and the second address generator are alternately switched.

Further, according to the present invention, the size of the software can be reduced, the time required for storing the data can be shortened, and the processing load can be reduced. Therefore, the operating frequency can be reduced, and the consumption of electric power can be reduced.

### BRIEF DESCRIPTION OF THE DRAWINGS

FIG. 1 is a schematic diagram showing the structure of the audio data storage device of the present invention.

FIG. 2 is a block diagram showing the structure of the address generator in FIG. 1.

FIG. 3 is a flowchart showing the operation of the device of the present invention shown in FIG. 1.

FIG. 4 is a schematic diagram showing PCM data in a PCM data buffer in mode 0 according to the present invention.

FIGS. 5A and 5B are schematic diagrams showing the status of the PCM data buffer which has output the PCM data in mode 0 and stored the PCM data of 0 ch in mode 1 according to the present invention.

FIG. 6 is a schematic diagram showing the PCM data stored in the PCM data buffer in mode 1 according to the present invention.

FIG. 7 is a schematic diagram showing the structure of the audio data encoder using the audio data storage device of the second embodiment of the present invention.

FIG. 8 is a schematic diagram showing the structure of a conventional audio data storage device.

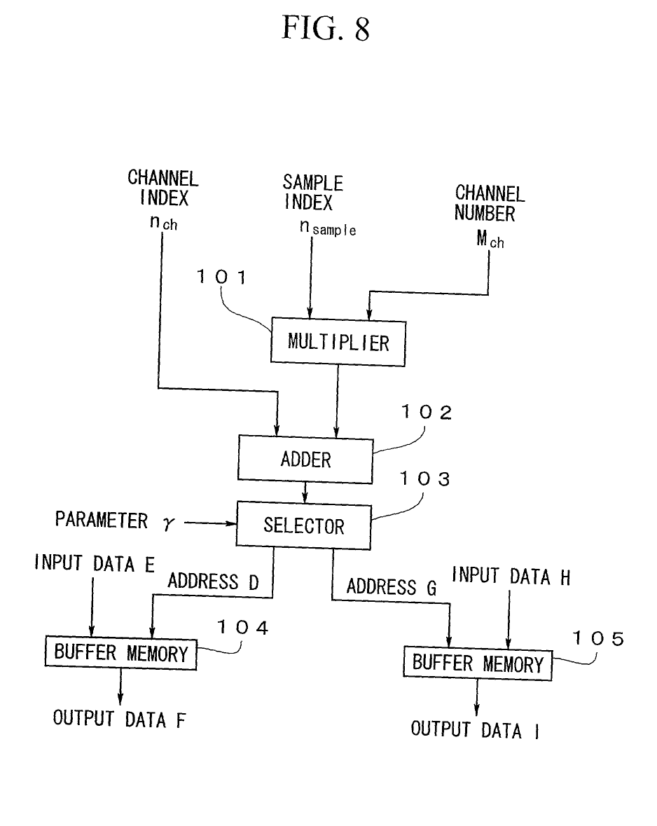

FIGS. 9A and 9B are schematic diagrams showing the operation of a conventional audio data storage device.

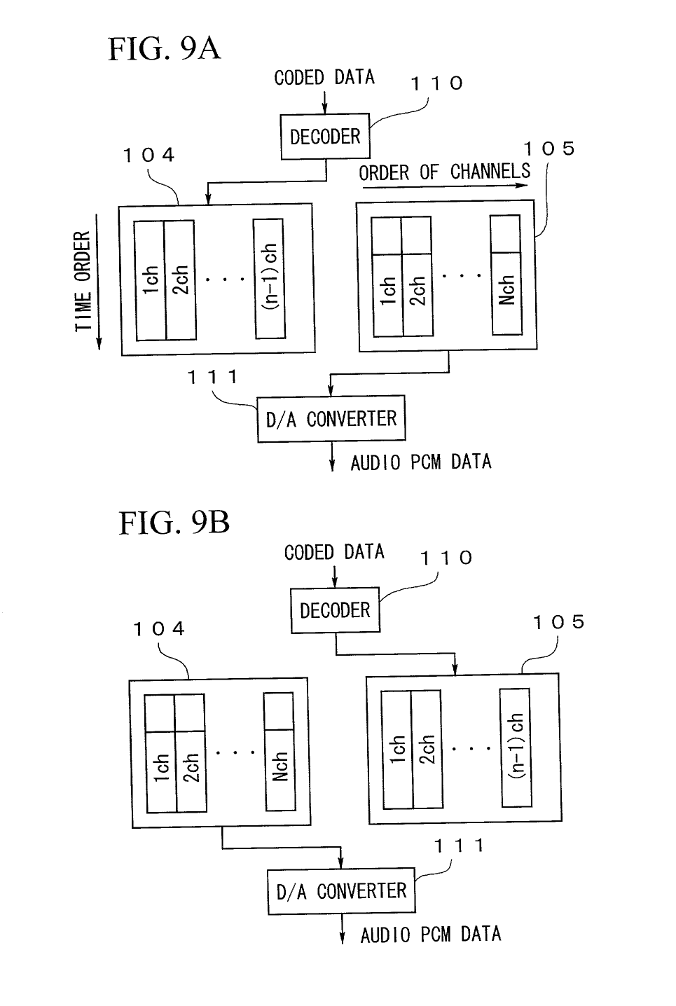

### DETAILED DESCRIPTION OF THE INVENTION

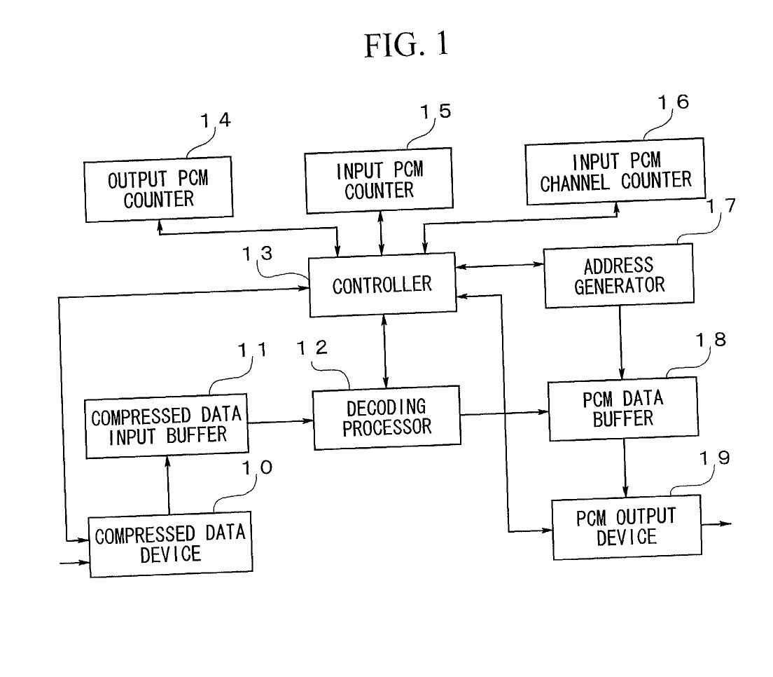

The audio data storage device of the present invention will be explained with reference to the drawings. This embodiment employs the MPEG2-AAC, and utilizes six channels and 1024 PCM data units in one frame. FIG. 1 is a schematic diagram showing the structure of the audio data storage device of this embodiment. In FIG. 1, a compressed data input device 10 outputs the PCM data, which is contained in coded audio data input from an external device, to a compressed data input buffer 11. The compressed data input device 10 detects an identification code contained in the input coded audio data, outputs the detected code to a controller 13, and detects the head of the frame which leads each channel.

The compressed data input buffer 11 temporarily stores the coded PCM data output from the compressed data input device 10, and outputs the data to a decoding processor 12. The decoding processor 12 decodes the coded PCM data on a frame basis, and outputs the decoded PCM data to a PCM data buffer 18. A controller 13 counts the number of channels Mch in the coded audio data, and the number of samples Msample which is the number of PCM data units in one frame based on the detected identification code output from the compressed data input device 10. The controller 13 also outputs a control signal (parameter) β, which gives instructions to switch the mode to mode 0 or mode 1 for producing a write or read address, to an address generator 17. Further, the controller 13 controls all of the portions of the device (the control process will now be explained in detail).

An output PCM counter 14 counts the number of PCM data units output from the PCM data buffer 18 to a PCM output device 19, via the controller 13, and outputs the count value to the controller 13. An input PCM counter 15 counts the number of the PCM data units output from the decoding processor 12 to the PCM data buffer 18, via the controller 13, and outputs the count value to the controller 13. An input PCM channel counter 16 counts the number of channels which is to be decoded by a decoding processor 12, via the controller 13, and outputs the count value to the controller 13.

The address generator 17 generates and outputs an address for storing the PCM data output from the decoding processor 12, into the PCM data buffer 18, and generates an address to which the PCM data, which is to be output from the PCM data buffer 18 to the PCM output device 19, is stored. These addresses are produced by mode 0 and mode 1 which are described below. The mode is switched between the two modes based on the control signal (parameter) β sent from the controller 13.

Mode 0 and mode 1 will now be explained. The address generator 17 generates an address based on the number of channels Mch output from the controller 13, the number of samples Msample, the sample index nsample which is time data corresponding to the sampling time contained in the PCM data to be read or written, and the channel index nch which is the channel number to be read or written. At that time, 0≦nsample<Msample, and 0≦nch<Mch. The sample index nsample is the count value of the output PCM counter 14 when generating the read address, and is the count value of the input PCM counter 15 when generating the write address.

When in mode 0, the address generator 17 generates an address mode 0_address(nch, nsample) for mode 0 according to Formula (1) using the above parameters.

mode 0_address(nch, nsample)=int(nsample/α)+(nsample % α)*Mch+α*nch (1)

Here, the parameter α is determined by Msample/Mch based on the number of channels Mch and the number of samples Msample, and the values after the decimal point are rounded up. int(x) represents that the values after the decimal point are omitted, and x % y represents the remainder of x/y. In the following, the address mode 0_address(nch, nsample) is referred to simply as mode 0_address.

When in mode 1, the address generator 17 generates the address mode 1_address(nch, nsample) according to Formula (2).

mode 1_address(nch, nsample)=nsample*Mch+nch (2)

In the following, the address mode 1_address(nch, nsample) is referred to simply as mode 1_address.

The relationship between the addresses generated in mode 0 and in mode 1 according to Formulas (1) and (2) is shown by the following Formulas (3) and (4).

mode 0_address(nch, all samples)=mode 1_address(all channels, α*nch˜α*(nch+1)−one sample) (3)

mode 1_address(nch, all samples)=mode 0_address(all channels, α*nch˜α*(nch+1)−one sample) (4)

The PCM data buffer 18 stores the PCM data output from the decoding processor 12 to the address set by the address generator 17. The PCM data buffer 18 outputs the PCM data from the address set by the address generator 17 to the PCM output device 19. The PCM output device 19 outputs PCM data units having the same channel index nsample in the respective channels together to an external device.

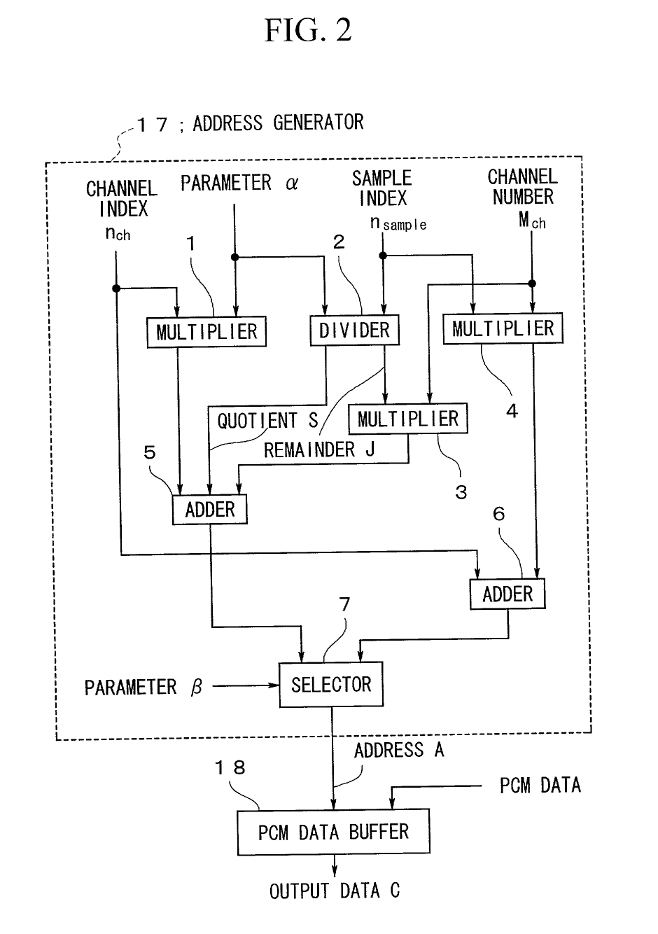

Referring to FIG. 2, the address generator 17 will now be explained in detail. In FIG. 2, the address generator 17 comprises a multiplier 1, a divider 2, a multiplier 3, a multiplier 4, an adder 5, an adder 6, and a selector 7. The multiplier 1 outputs the product of the parameter a and the channel index nch. The divider 2 divides the sample index nsample by the parameter α to obtain a quotient S and a remainder J, outputs the quotient S to the adder 5, and outputs the remainder J to the multiplier 3.

The multiplier 3 outputs the product of the remainder J and the number of channels Mch to the adder 5. The multiplier 4 outputs the product of the sample index nsample and the number of channels Mch to the adder 6. The adder 5 outputs the sum of the output from the multiplier 1, the output from the multiplier 3, and the quotient S. The adder 6 outputs the sum of the channel index nch, the quotient S, and the output from the multiplier 4. The selector 7 selects the output from the adder 5 when the parameter β set by the controller 13 is 0 (when in mode 0), selects the output from the adder 6 when the parameter β is 1 (when in mode 1), and outputs the output as an address A to the PCM data buffer 18.

The PCM data buffer 18 stores the PCM data output from the decoding processor 12 to the address A specified by the selector 7, and outputs the PCM data as output data C from the address A specified by the selector 7 to the PCM output device 19.

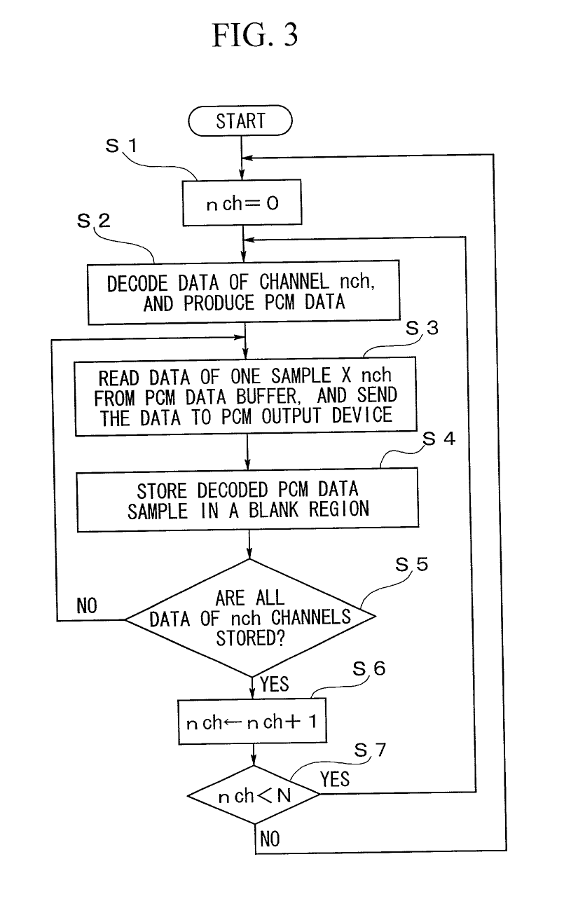

Next, the operation of the device shown in FIG. 1 will be explained with reference to the flowchart of FIG. 3. After the power is turned on, the controller 13 sets the count values of the output PCM counter 14, the input PCM counter 15, and the input PCM channel counter 16 to 0, and deletes the PCM data from the PCM data buffer 18. When receiving the coded audio data as an input, a compressed data input device 10 detects the identification code in the coded audio data, outputs the code to the controller 13, detects the head of the frame corresponding to each channel, and outputs the result of the detection to the controller 13. The compressed data input device 10 outputs the coded PCM data in the audio data to the compressed data input buffer 11.

The controller 13 detects a value of 6 as the number of channels Mch, and 1024 as the number of samples Msample, based on the detected identification code output from the compressed data input device 10. Further, when receiving the signal indicating that the head of the frame is detected, the controller 13 sets the number of channels to be decoded to 0 ch (in step S1), sends the instruction to decode the PCM data of 0 ch to the decoding processor 12, and outputs a value of 6 which is the number of channels Mch, and 1024 which is the number of samples Msample to the address generator 17. When the decoding processor 12 is instructed to perform the decoding process by the controller 13 and receives the coded PCM data from the compressed data input buffer 11, the 0 ch decoding processor 12 decodes the coded PCM data, and produces the PCM data (step S2).

Then, although the controller 13 is to output the PCM data stored in the PCM data buffer 18, this portion of step S3 is omitted because not all of the PCM data is stored, until the PCM data of all the channels is stored in the PCM data buffer 18.

Then, the controller 13 instructs the address generator 17 to set the control signal (parameter) β to 0 and to generate the address in mode 0. The address generator 17 generates the mode 0_address according to Formula (1) based on the number of channels Mch which is 6, the number of samples Msample which is 1024 , the value counted by the input PCM counter 15 which is 0, and the value counted by the input PCM channel counter 16 which is 0. The address generator 17 sets the generated mode 0_address to the PCM data buffer 18. When receiving one PCM data unit from the decoding processor 12, the PCM data buffer 18 stores the PCM data unit in the mode 0_address set by the address generator 17 (in step S4). When the PCM data is stored in the PCM data buffer 18, the input PCM counter 15 increments the count by one.

The controller 13 determines whether all the PCM data units of 0 ch are stored based on the value counted by the input PCM counter 15 and the number of samples Msample (step S5).

If all the data units have not been stored, the controller 13 omits the data sending portion of step S3, and instructs the address generator 17 to generate the address in mode 0. The address generator 17 generates the mode 0_address according to Formula (1) based on a value of 1 which is the value counted by the input PCM counter 15 and the above-described parameters, and sets the address to the PCM data buffer 18. Upon receiving one PCM data unit from the decoding processor 12, the PCM data buffer 18 stores the PCM data unit in the mode 0_address set by the address generator 17 (step 4). When the PCM data unit is stored in the PCM data buffer 18, the input PCM counter 15 increments the count by one.

The process from step S3 to step S5 is repeated until all the PCM data units of 0 ch are stored in the PCM data buffer 18.

After all the PCM data of 0 ch has been stored, in response to the input of the coded PCM data of 1 ch, the compressed data input device 10 detects the head of the frame, and outputs a signal indicating the detection to the controller 13. When the compressed data input device 10 outputs the signal indicating the detection of the head of the frame, the controller 13 sets the channel number nch which is to be decoded to 1 ch, and instructs the decoding processor 12 to decode the PCM data of 1 ch. At that time, the input PCM channel counter 16 increments the count by one (step S6). The controller 13 determines whether the decoding process for all the channels is completed based on the value counted by the input PCM channel counter 16 and the number of channels Mch (step S7).

Since the decoding process for all the channels has not been completed, the controller 13 instructs the decoding processor 12 to decode the data of 1 ch. The decoding processor 12 receives the coded PCM data from the compressed data input buffer 11, decodes the coded PCM data in response to the instruction to decode the data of 1 ch from the controller 13, and produces the PCM data (step S2).

The controller 13 omits the data sending portion of step S3, and instructs the address generator 17 to generate the address in mode 0. The address generator 17 generates the address according to Formula (1) based on a value of 0 which is the value counted by the input PCM counter 15, and a value of 1 which is the value counted by the input PCM channel counter 16, and sets the generated mode 0_address to the PCM data buffer 18. Upon receiving one PCM data unit from the decoding processor 12, the PCM data buffer 18 stores the PCM data into the address set by the address generator 17 (step S4). After the PCM data has been stored in the data buffer 18, the input PCM counter 15 increments the count by one. Then, steps S3 to S5 are repeated until all the PCM data of 1 ch is stored in the PCM data buffer 18.

After all the PCM data of 1 ch has been stored, in response to the input of the coded PCM data of 2 ch, the compressed data input device 10 detects the head of the frame, and outputs a signal indicating the detection to the controller 13. When the compressed data input device 10 outputs the signal indicating the detection of the head of the frame, the controller 13 sets the channel number nch which is to be decoded to 2 ch, and instructs the decoding processor 12 to decode the PCM data of 2 ch. At that time, the input PCM channel counter 16 sets the count value to 2 (step S6). The controller 13 determines whether the decoding process for all the channels is completed, based on the value counted by the input PCM channel counter 16 and the number of channels Mch (step S7).

If the decoding process for all the channel has not been completed, the controller 13 instructs the decoding processor 12 to decode the data of 2 ch. Steps S2 to S7 are repeated until the data of all the channels has been decoded.

When the data of all the channels (0 ch to 5 ch) has been decoded, and when all the PCM data has been stored, the controller 13 sets the channel which is to be decoded to 0 ch (step S1), and performs step S2.

The controller 13 instructs the address generator 17 to output the PCM data of the respective channels 0 to 5 ch in mode 0. In response to the instruction from the controller 13, the address generator 17 generates the mode 0_addresses for the channels 0 ch to 5 ch according to Formula (1) based on the number of channels which is 6, the number of samples Msample which is 1024 , the value counted by the output PCM counter 14 which is 0, and the channel number which is 0. The address generator 17 sets the generated mode 0_addresses successively in the PCM data buffer 18. Whenever the address generator 17 sets the mode 0_address, the PCM data buffer 18 outputs the PCM data from the address to the PCM output device 19 (step S3). Thus, the PCM data of 0 ch to 5 ch whose sample index nsample is set to 0 is output to the PCM output device 19. The PCM output device 19 outputs the data from the PCM data buffer 18 together to an external device. The output PCM counter 14 sets the count value to 1.

The controller 13 instructs the address generator 17 to generate the address in mode 1. That is, the controller 13 sends an instruction to generate six addresses because six PCM data units have been output in step S3. The address generator 17 generates the mode 1_addresses according to Formula (2) based on the value counted by the input PCM counter 15 which is 0, and the above-described parameters, and sets the addresses in the PCM data buffer 18. When the PCM data buffer 18 receives one PCM data unit from the decoding processor 12, the PCM data buffer 18 stores the PCM data in the mode 1_address set by the address generator 17 (step S4). When the PCM data is stored in the PCM data buffer 18, the input PCM counter 15 increments the count by one. The address generator 17 successively generates the addresses until the remaining five PCM data units have been stored in the PCM data buffer 18. In this case, after all the data of 0 ch has been stored, the flow proceeds to step S5 even if six addresses have not been generated. The controller 13 determines whether all the PCM data of 0 ch has been stored (step S5). If all the PCM data has not been stored, the process of steps S3 to S5 is performed until all the PCM data has been stored.

After all the PCM data of 0 ch has been stored, in response to the input of the coded PCM data of 1 ch, the compressed data input device 10 detects the head of the frame, and outputs a signal indicating the detection to the controller 13. The controller 13 changes the channel number which is to be decoded from 0 ch to 1 ch, and instructs the decoding processor 12 to decode the PCM data of 1 ch. At that time, the input PCM channel counter 16 sets the count value to 1 (step S6). The controller 13 determines whether the decoding process for all the channels has been completed based on the value counted by the input PCM channel counter 16 and the number of channels Mch (step S7). Because all the channels have not been decoded, the controller 13 instructs the decoding processor 12 to decode the data of 1 ch.

If all the channels have not been decoded, the controller 13 instructs the decoding processor 12 to decode the data of 1 ch. Steps S2 to S7 are repeated until all the channels are decoded.

After all the channels (0 ch to 5 ch) are decoded and the PCM data has been stored, the controller 13 sets the channel number to be decoded to 0 ch (step S1), and performs step S2.

Then, the controller 13 instructs the address generator 17 to output the PCM data of the respective channels 0 ch to 5 ch in mode 1. The address generator 17 generates the mode 1_addresses according to Formula (2), and successively sets the generated mode 1_addresses in the PCM data buffer 18. Whenever the address generator 17 sets the mode 1_address, the PCM data buffer 18 outputs the PCM data from the address to the PCM output device 19.

The controller 13 instructs the address generator 17 to generate six addresses in mode 0. The address generator 17 generates the mode 0_address according to Formula (1), and sets the address in the PCM data buffer 18. The PCM data buffer 18 stores the PCM data, which was output from the decoding processor 12, at the mode 0_address set by the address generator 17 (step S4). Whenever the PCM data buffer 18 stores the PCM data, the input PCM counter 15 increments the count by one. Then, the address generator 17 successively generates the addresses until the remaining five PCM data units have been stored in the PCM data buffer 18.

Next, the status of the data stored in the PCM data buffer 18 in mode 0 and mode 1 is explained with reference to the drawings.

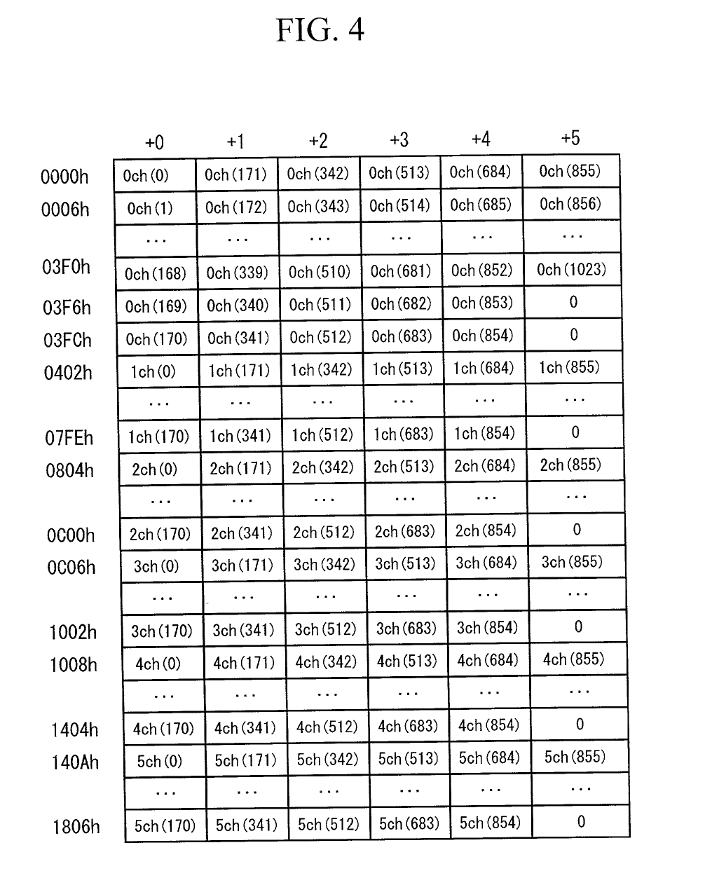

FIG. 4 shows the data stored in mode 0. As shown in FIG. 4, the PCM data of 0 ch is stored in the region of the addresses 0000(h) to 03FA(h) and 03FCh to 0400h. The PCM data of 1 ch is stored in the region of the addresses 0402h to 0803h, and the PCM data of 2 ch is stored in the region of the addresses 0804h to 0C05h. Similarly, the PCM data up to 5 ch is stored in sequence in the horizontal direction.

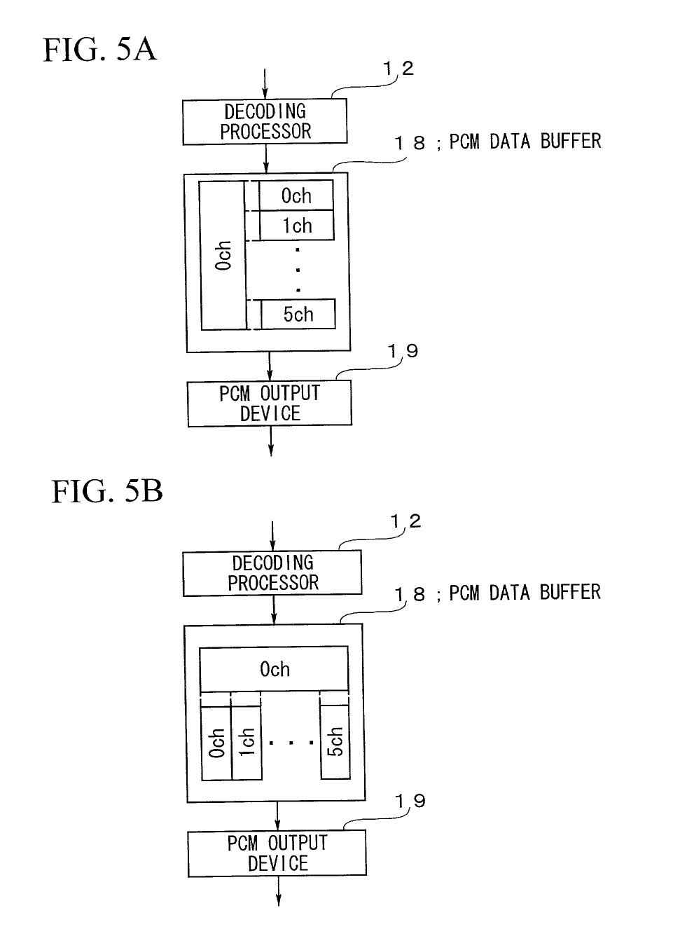

In this situation, in response to the instruction from the controller 13, the PCM data is output in mode 0. The PCM data of 0 ch is written in the storage region from which the previous PCM data has been output. Then, the status of the data in the PCM data buffer 18 is changed as shown in FIG. 5A.

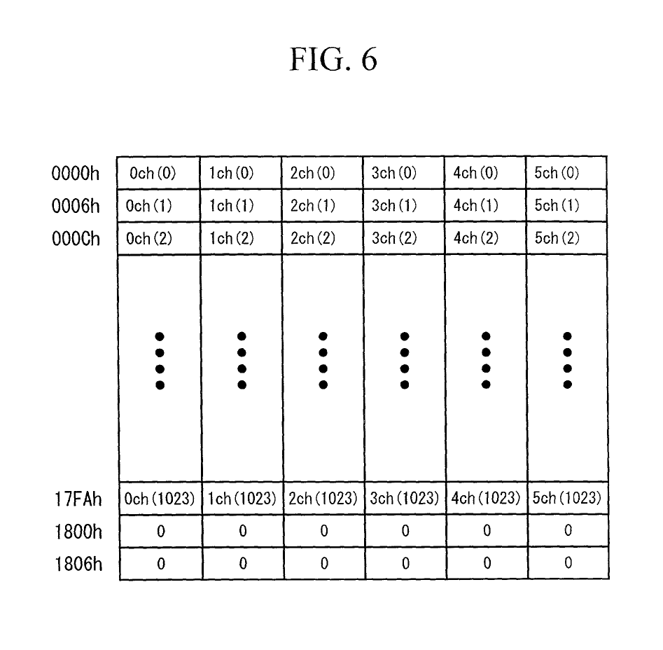

For example, the PCM data units from the sample indexes 0 to 341 in the respective channels are output in mode 0, and the PCM data of one frame of 0 ch is input. The status of this data is shown in FIG. 6A. In FIG. 5A, the data stored in mode 0 has been output, and the data of 1 ch is stored in the writable region in mode 1.

FIG. 6 shows the status of the PCM data buffer 18 from which stores all the PCM data of 0 ch to 5 ch in mode 1 in the region from which the PCM data has been output in mode 0. In FIG. 6, the data of 0 ch is stored in sequence in the vertical direction from 0000h, 0006h, 000Ch, . . . , 17FAh. Further, the data of 1 ch is stored in sequence in the vertical direction from 0001h, 0007h, . . . , 17FBb. Thereafter, the data units from 2 ch to 5 ch are also stored in sequence in the vertical direction.

FIG. 5B shows the status of the memory which stores the PCM data of one frame of 0 ch after the time data units 0 to 341 in the respective channels have been output in mode 1. As shown in FIG. 5B, the data of 0 ch is stored in mode 0 in the writable region from which the data stored in mode 1 is output in mode 1.

As described above, by alternatively switching the mode between mode 0 and mode 1 to read and write the PCM data, the PCM data output from the decoding processor 12 is not overwritten on the PCM data which has not yet been read from the PCM data buffer 18. Therefore, this invention can store the PCM data in a single buffer memory, and thereby reduces the necessary storage region.

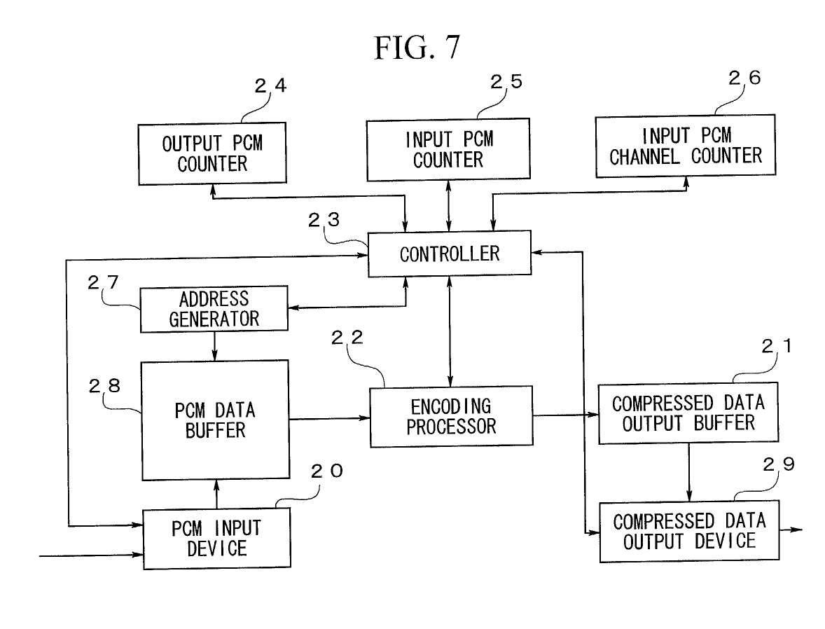

The second embodiment of the present invention will now be explained. FIG. 7 shows the structure of the audio data coder, to which the audio data storage device is applied, for coding the audio data. In FIG. 7, a PCM input device 20 outputs the PCM data contained in the six channels of audio data, which are input from an external device and decoded, to a PCM data buffer 28.

An address generator 27 generates the address for storing the PCM data, which was output from the PCM input device 20, into the PCM data buffer 28, and generates and outputs the address for outputting the PCM data from the PCM data buffer 28 to an encoding processor 22. These addresses are generated by mode 0 and mode 1 based on a control signal (parameter) β specified by a controller 23. Formulas used in mode 0 and in mode 1 are the same as the above-described formulas (1) and (2) in the first embodiment. The structure of the address generator 27 is the same as that of the first embodiment shown in FIG. 2.

The PCM data buffer 28 stores the PCM data, which was output from the PCM output device 20, to the address specified by the address generator 27. The PCM data buffer 28 outputs the PCM data from the address specified by the address generator 27 to the encoding processor 22. The status of the PCM data stored in the PCM data buffer 28 in a fashion similar to the first embodiment as shown in FIGS. 4 and 6.

The encoding processor 22 encodes the decoded PCM data of the respective channels output from the PCM data buffer 28, and outputs the encoded PCM data to a compressed data output buffer 21. The compressed data output buffer 21 temporarily stores the encoded PCM data which was output from the encoding processor 22, and then outputs the data to a compressed data output device 29. The compressed data output device 29 outputs the PCM data of one frame in the respective channels together to an external device.

The controller 23 outputs the control signal (parameter) β for instructing the switching of the mode between mode 0 and mode 1 for generating the write and read addresses, to the address generator 17. The controller 23 stores the number of channels Mch (=6) to be input, and the number of all the samples Msample (=1024) in advance. Further, the controller 23 controls all of the portions in the device (the control process will now be explained in detail).

An output PCM counter 24 counts the number of PCM data units output from the PCM data buffer 28 to the encoding processor 22, via the controller 23, and outputs the count value to the controller 23. An input PCM counter 25 counts the number of PCM data units which are output from the PCM input device 20 and stored in the data buffer 28, via the controller 23, and outputs the count value to the controller 23. An input PCM channel counter 26 counts the number of channels through which the PCM data is output from the PCM input device 20, via the controller 23, and outputs the count value to the controller 23.

The operation of the device shown in FIG. 7 will now be explained. When the power is turned on, the controller 23 sets the count values of the output PCM counter 24, the input PCM counter 25, and the input PCM channel counter 26 to 0. In response to the input of the PCM data units of 0 ch to 5 ch which have the same sample index into the PCM input device 20, the PCM input device 20 outputs the input PCM data units of the respective channels to the PCM data buffer 28. At that time, the input PCM counter 25 counts the number of the same input sample indexes of the PCM data output from the PCM input device 20 to the PCM data buffer 28. The input PCM channel counter 26 counts the number of channels of the PCM data units which have been successively output to the data buffer 28 on a channel basis.

Whenever the PCM input device 20 outputs the PCM data, the controller 23 instructs the address generator 27 to generate the address in mode 0, and outputs the total number of the channels which is 6, and the total number of samples which is 1024. According to the instruction from the controller 23, the address generator 27 generates the mode 0_address according to Formula (1) based on the value counted by the input PCM counter 25, the value counted by the input PCM channel counter 26, the total number of input channels which is 6, and the total number of sample data units which is 1024, whenever the PCM input device 20 outputs the PCM data, and sets the address in the PCM data buffer 28.

The PCM data buffer 28 successively stores the PCM data units output from the PCM input device 20 into the mode 0_address set by the address generator 27. Then, when 1024 PCM data units in each channel have been stored in the PCM data buffer 28 based on the value counted by the input PCM counter 25, the status of the PCM data buffer 28 is as shown in FIG. 4.

After all the PCM data units of all the channels have been stored in the PCM data buffer 28, the controller 23 instructs the address generator 27 to generate the address for reading the PCM data of 0 ch in mode 0. The address generator 27 generates the mode 0_addresses indicating the locations at which the PCM data units whose indexes are 0 to 1023 are stored, according to Formula (1) based on the value counted by the output PCM counter 24, and sets the addresses in the PCM data buffer 28. The PCM data buffer 28 successively outputs the PCM data, which has been stored at the address specified by the address generator 27, to the encoding processor 22. When the PCM data buffer 28 outputs all the PCM data of 0 ch, the encoding processor 22 encodes all the PCM data of 0 ch, and outputs the encoded PCM data of 0 ch to the compressed data output buffer 21. The compressed data output buffer 21 outputs the encoded PCM data of 0 ch which was output from the encoding processor 22, through the compressed data output device 29 to an external device. Similarly, whenever the address generator 27 sets the address, the other PCM data of 1 ch to 5 ch which is stored in the PCM data buffer 28 is output to the encoding processor 22.

After the PCM data of 0 ch has been output, when the PCM data of 0 ch to 5 ch with the same sample index is input to the PCM input device 20, the controller 23 instructs the address generator 27 to successively generate the addresses into which the PCM data units are to be written in mode 1. The address generator 27 generates the mode 1_addresses according to Formula (2), and sets the addresses in the PCM data buffer 28. The PCM data buffer 28 successively stores the PCM data units output from the PCM input device 20, into the mode 1_addresses set by the address generator 27. The PCM data units of all of the channels in mode 1 which have been input into the PCM data buffer 28 are shown in FIG. 6.

The PCM data stored in the PCM data buffer 28 is output to the encoding processor 22 whenever the address generator 27 sets the address in mode 1.

Then, the controller 23 switches the mode between mode 0 and mode 1 to write and read the PCM data to and from the PCM data buffer 28.

As described above, because the input PCM data is written to the address from which the previous PCM data has been read, the memory size of the data buffer for storing the audio PCM data can be decreased. For example, because the conventional technique requires two buffer memories for storing 6144 (=1024×6) samples, a total of 12288 (=6144×2) samples are stored. The present invention requires only one buffer memory for storing 6156 (=1026×6) samples.

In the above-described embodiments, according to the MPEG2-AAC, the number of channels is six, and the number of PCM data units in one frame is 1024 . The present invention can be applied to standards other than the standard which defines six channels and 1024 PCM data units. For example, the present invention can be applied to AC-3 (which defines six channels and 256 data units in each channel) proposed by Dolby Laboratories Inc. in the USA.

In the first embodiment, the controller 13 detects the number of channels Mch, and the number of sample data units Msamples based on the detection of the identification code output from the compressed data input device 10. The number of channels Mch, and the number of sample data units Msample may be stored in advance, and may be read if necessary.

The computer program for providing the functions of the controller 13, and the address generator 17 in FIG. 1 may be recorded in a computer-readable storage medium, may be read by a computer system, and may be executed. The computer system includes an OS and hardware such as peripheral devices.

The computer-readable storage medium is, for example, a removable medium such as a floppy disk, an optical magnetic disk, a ROM, or a CD-ROM, or a storage device such as a hard disk provided in the computer system. Further, the computer-readable storage medium may be a medium for holding data for a predetermined time such as a non-volatile memory (RAM) in the computer system which acts as a server or client when a program is transmitted through a network such as the Internet, or through a communication line such as a telephone line.

The program may be transmitted from the computer which stores the program in the storage device to another computer system using a transmission medium, or using a carrier wave in the transmission medium. The transmission medium means a medium having a function for transmitting information such as a network (communication network), e.g., the Internet, or a communication line such as a telephone line.

The program may provide a part of the above-described functions. Further, the functions may be provided by combining the program, which has been installed in the computer system, with an update file (or an update program).

This invention may be embodied in other forms or carried out in other ways without departing from the spirit thereof The present embodiments are therefore to be considered in all respects illustrative and not limiting, the scope of the invention being indicated by the appended claims, and all modifications falling within the meaning and range of equivalency are intended to be embraced therein.

1. An audio data storage device comprising:
a storage device for storing audio data;
a channel detector for detecting a channel of the audio data;
an input sample number detector for detecting the number of samples of the audio data to be written into the storage device;
an output sample number detector for detecting the number of samples of the audio data to be read from the storage device;
an address generator for generating an address for writing and reading the audio data based on the channel detected by the channel detector, the number detected by the input sample number detector, the number detected by the output sample number detector, the number of channels of the audio data, and the number of samples included in one channel; and
a controller for directing the storage device to read and write the audio data based on the address generated by the address generator.

2. An audio data storage device according to claim 1, further comprising:
a decoder for decoding coded audio data, wherein
the storage device stores the decoded audio data.

3. An audio data storage device according to claim 1, wherein the controller detects the number of channels and the number of samples included in the coded audio data, and outputs the numbers to the address generator.

4. An audio data storage device according to claim 1, further comprising:
an encoder for encoding audio data with a plurality of channels, wherein
the storage device stores the audio data which is to be encoded.

5. An audio data storage device according to claim 1, wherein the controller stores the number of channels and the number of samples included in the encoded audio data, in advance.

6. An audio data storage device according to claim 1, wherein the address generator generates an address of the data to be read, in response to an instruction from the controller to read the data, and
the address generator generates an address of the data which has been read, in response to an instruction from the controller to write the data.

7. An audio data storage device according to claim 1, wherein the address generator comprises:
a first address generator for specifying a first sequence of addresses; and
a second address generator for specifying a second sequence of addresses, wherein
the controller directs the storage device to read and write the audio data while alternately switching the first address generator and the second address generator.

8. An audio data storage device according to claim 1, wherein the storage device, the channel detector, the input sample number detector, the output sample number detector, the address generator, and the controller are provided in a semiconductor device.

9. An audio data storage device according to claim 8, further comprising:
a decoder for decoding coded audio data, wherein
the storage device stores the decoded audio data.

10. An audio data storage device according to claim 8, wherein the controller detects the number of channels and the number of samples included in the coded audio data, and outputs the numbers to the address generator.

11. An audio data storage device according to claim 8, further comprising:
an encoder for encoding audio data with a plurality of channels, wherein
the storage device stores the audio data which is to be encoded.

12. An audio data storage device according to claim 8, wherein the controller stores in advance the number of channels and the number of samples included in the encoded audio data.

13. An audio data storage device according to claim 8, wherein the address generator generates an address of the data to be read, in response to an instruction from the controller to read the data, and
the address generator generates an address of the data which has been read, in response to an instruction from the controller to write the data.

14. A computer-readable storage medium containing program instructions for performing the steps comprising:
a storage step for storing audio data;
a channel detecting step for detecting a channel of the audio data;
an input sample number detecting step for detecting the number of samples of the audio data to be written in the storage step;
an output sample number detecting step for detecting the number of samples of the audio data to be read in the storage step;
an address generating step for generating an address for writing and reading the audio data, based on the channel detected by the channel detecting step, the number detected by the input sample number detecting step, the number detected by the output sample number detecting step, the number of channels of the audio data, and the number of samples included in one channel; and
a control step for directing the storage step to read and write the audio data, based on the address generated by the address generating step.

15. A computer readable storage medium according to claim 14 containing program instructions for performing the steps further comprising:
a decoding step for decoding coded audio data, wherein
the storage step stores the decoded audio data.

16. A computer readable storage medium according to claim 14 containing program instructions for performing the steps further comprising:
an encoding step for encoding audio data with a plurality of channels, wherein
the storage step stores the audio data which is to be encoded.
